(19) United States
(12) Patent Application Publication
(10) Pub. No.: US 2025/0209274 A1
(43) Pub. Date: Jun. 26, 2025

(54) TEXT RECOGNITION METHOD AND APPARATUS, ELECTRONIC DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Tao YANG, Shenzhen (CN)

(21) Appl. No.: 19/075,424

(22) Filed: Mar. 10, 2025

Related U.S. Application Data
(63) Continuation of application No. PCT/CN2023/129845, filed on Nov. 6, 2023.

(30) Foreign Application Priority Data
Mar. 10, 2023 (CN) 202310262181.4

(51) Int. Cl. G06F 40/295; G06F 18/2131

(52) U.S. Cl. CPC G06F 40/295; G06F 18/2131

(57) ABSTRACT

Disclosed are a text recognition method and apparatus, an electronic device, a storage medium, and a program product. The method includes performing a training iteration on a text recognition model based on a pre-constructed text sample set and a reference model, to obtain a trained text recognition model; and inputting text to be recognized into the trained text recognition model, and recognizing a named entity in the text to be recognized, to obtain text content corresponding to the named entity. Each training iteration comprises respectively inputting a text sample selected from the text sample set into the reference model and the text recognition model; obtaining an output difference and a prediction difference; and adjusting parameters of the text recognition model based on the output differences and the prediction difference.

### RELATED APPLICATIONS

This application is a continuation of PCT Application No. PCT/CN2023/129845, filed on Nov. 6, 2023, which claims priority to Chinese Patent Application No. 202310262181.4, filed with the China National Intellectual Property Administration on Mar. 10, 2023, and entitled “TEXT RECOGNITION METHOD AND APPARATUS, ELECTRONIC DEVICE, AND STORAGE MEDIUM”, which are both incorporated herein by reference in their entirety.

### FIELD OF THE TECHNOLOGY

This application relates to the field of computer technologies, and in particular, to a text recognition method and apparatus, an electronic device, a storage medium, and a program product.

### BACKGROUND OF THE DISCLOSURE

With the rapid development of deep learning technology, the performance of a model, especially the accuracy of the model, has been significantly improved. Furthermore, continuously increasing model parameters can further enhance the accuracy of the deep learning model to a certain extent. However, the exponential growth of model parameters leads to a larger model size, which in turn increases computing resources consumed by the model operation, and extends the time needed by the model to process a task. This results in slower response for online applications and imposes higher requirements on hardware. Therefore, it is difficult to apply large models in real-world scenarios.

Various simplification techniques have been used on the model, but these often lead to a reduction in model precision and accuracy. This issue is particularly pronounced in a text recognition scenario, where the model obtained by the foregoing methods exhibit reduced accuracy in text recognition.

Based on the above, how to improve the accuracy of text recognition is an urgent problem that needs to be solved.

### SUMMARY

Embodiments of this application provide a text recognition method and apparatus, an electronic device, a storage medium, and a program product, to improve the accuracy of text recognition.

The embodiments of this application provide a text recognition method, which includes performing at least one training iteration on a text recognition model to be trained based on a pre-constructed text sample set and a reference model, to obtain a trained text recognition model; and inputting text to be recognized into the trained text recognition model, and recognizing a named entity in the text to be recognized, to obtain text content corresponding to the named entity. Each training iteration comprises respectively inputting a text sample selected from the text sample set into the reference model and the text recognition model, the reference model comprising at least one first transformer configured to extract a feature, the text recognition model comprising at least one second transformer configured to extract a feature; obtaining an output difference between each second transformer and the corresponding first transformer of the reference model based on a transformer mapping relationship; obtaining a prediction difference between the text recognition model and the reference model for mask information in the text sample; and adjusting parameters of the text recognition model based on the output differences and the prediction difference.

The embodiments of this application provide an electronic device, which includes a processor and a memory. The memory has a computer program stored therein, and the processor, when executing the computer program, performs the operations of the foregoing text recognition method.

The embodiments of this application provide a non-transitory computer-readable storage medium, which includes a computer program. The computer program, when running on an electronic device, causes the electronic device to perform the operations of the foregoing text recognition method.

### BRIEF DESCRIPTION OF THE DRAWINGS

The accompany drawings described here are used to provide further understanding of this application and constitute a part of this application. The exemplary embodiments of this application and their descriptions are used to explain this application, and are not intended to constitute improper limitations on this application. In the drawings:

FIG. 1 is a schematic diagram of an application scenario of a text recognition method according to an embodiment of this application.

FIG. 2 is a complete flowchart of a text recognition method according to an embodiment of this application.

FIG. 3 is a schematic structural diagram of a reference model and a text recognition model according to an embodiment of this application.

FIG. 4 is a schematic diagram of inputting a text sample into a model according to an embodiment of this application.

FIG. 5 is a schematic diagram of a transformer mapping relationship according to an embodiment of this application.

FIG. 6 is a schematic logical diagram of acquisition of an output difference according to an embodiment of this application.

FIG. 7 is a schematic logical diagram of acquisition of a prediction difference according to an embodiment of this application.

FIG. 8 is a flowchart of another text recognition method according to an embodiment of this application.

FIG. 9 is a logical diagram of an interaction between a terminal device and a server when a text recognition model is applied according to an embodiment of this application.

FIG. 10 is a schematic structural diagram of a composition of a text recognition apparatus according to an embodiment of this application.

FIG. 11 is a schematic structural diagram of a hardware composition of an electronic device according to an embodiment of this application.

FIG. 12 is a schematic structural diagram of a hardware composition of another electronic device according to an embodiment of this application.

### DESCRIPTION OF EMBODIMENTS

To make the objectives, technical solutions, and advantages of the embodiments of this application clearer, the following describes the technical solutions of this application clearly and completely with reference to the drawings in some embodiments of this application. Apparently, the embodiments described are some but not all of the embodiments of the technical solutions of this application. All other embodiments obtained by those of ordinary skill in the art based on the embodiments described in this application without involving any creative effort fall within the scope of protection of the technical solutions of this application.

The following introduces a few concepts involved in some embodiments of this application.

Reference model: a pre-trained, large-scale, and structurally complex model designed to guide distillation training of a text recognition model to be trained and having the same application direction as the text recognition model to be trained. That is, the reference model is a model applied to text recognition. In this application, the reference model may be referred to as a teacher model, and the text recognition model to be trained may also be referred to as a student model.

Distillation training: a process where a small model (such as a student model) learns to simulate prediction behavior of a large model (such as a teacher model), effectively transferring knowledge of the large model to the small model.

Text recognition model: a smaller and structurally simpler model designed to learn text recognition by imitating the reference model. It can be applied to a text recognition scenario after being trained.

Transformer: a module for feature extraction, where each transformer includes a self-attention sub-layer and a feedforward neural network (FNN) sub-layer.

Transformer mapping relationship: a correspondence between all second transformers of the text recognition model and particular first transformers of the reference model. Because the quantity of the first transformers of the reference model is greater than that of the second transformers of the text recognition model, it is necessary to determine which first transformer of the reference model corresponds to each second transformer of the text recognition model based on the transformer mapping relationship. This mapping can adopt various strategies, such as a one-to-one correspondence or matching several consecutive first transformers (the initial few or the final few first transformers) of the reference model to the second transformers of the text recognition model.

The embodiments of this application involve artificial intelligence (AI) and machine learning (ML), and are designed based on the computer vision technique in AI and ML.

The reference model and the text recognition model in some embodiments of this application are trained by ML or a deep learning technique.

After being trained by the foregoing method, the text recognition model is applicable to recognition of entity proper nouns in advertisement text, a book, and content of a topic discussion.

The following briefly introduces the design idea of the embodiments of this application.

To facilitate the application of large models in real-world scenarios, techniques such as model pruning and model quantization are commonly employed. Model pruning involves removing some layers of the model to make the model sparse, thereby reducing the amount of computation of the model. Model quantization involves compressing weights of the model originally stored as 32-bit floating point numbers into 16-bit, 8-bit, or 4-bit representations to reduce the size of the model weights and further reduce the memory requirements upon application in real-world scenarios. Alternatively, model pruning and model quantization may be used together. Nevertheless, both model pruning and model quantization frequently result in a notable reduction in model precision and a decline in model accuracy.

In view of this, the embodiments of this application provide a text recognition method and apparatus, an electronic device, and a storage medium. At least one training iteration is performed on a small-scale text recognition model based on a pre-constructed text sample set and a large-scale reference model. The text recognition model is small-scale and easy to apply in real-world scenarios. The text recognition model undergoes training under the supervision of the reference model, ensuring it maintains the highest possible accuracy in line with the reference model. In each training iteration, a text sample selected from the text sample set is inputted into the reference model and the text recognition model, respectively; parameters of the text recognition model are adjusted based on a prediction difference between the text recognition model and the reference model for mask information, an output difference between each of at least one transformer of the text recognition model and a corresponding target transformer of the reference model is acquired based on a transformer mapping relationship, and the parameters of the text recognition model are also adjusted based on the output differences. By this method, the text recognition model can not only fit an output of the last layer of the reference model, but also fit sub-layers of the reference model. The text recognition model can learn massive implicit knowledge contained in more parameters of the reference model, whereby the accuracy is further improved. Consequently, this enhances the precision of identifying a named entity within the text using the text recognition model.

The following describes preferred embodiments of this application with reference to the drawings. The preferred embodiments described here are merely used for describing and explaining this application, and are not intended to limit this application. The embodiments of this application or features of the embodiments may be combined in different manners without conflict to form other embodiments,

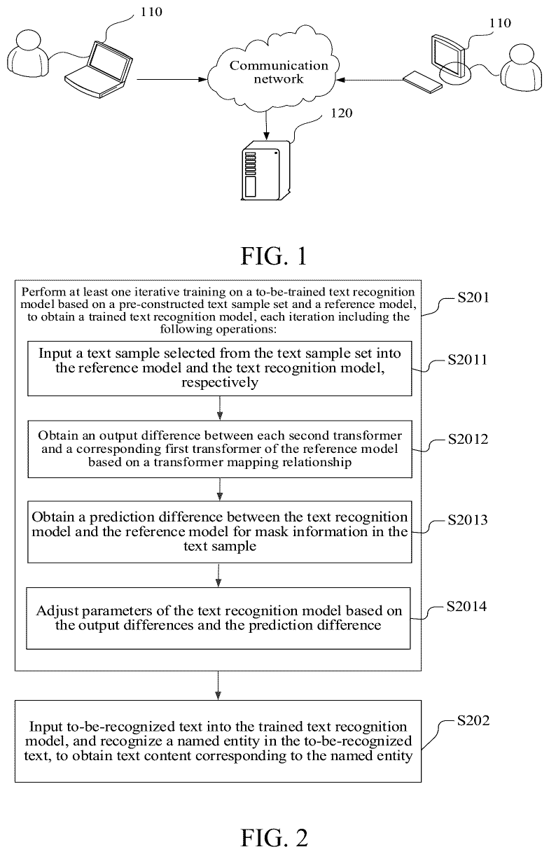

FIG. 1 is a schematic diagram of an application scenario of the embodiments of this application. The diagram of the application scenario includes two terminal devices 110 and one server 120.

In some embodiments of this application, the terminal device 110 includes, but is not limited to, devices such as a mobile phone, a tablet computer, a laptop computer, a desktop computer, an e-book reader, an intelligent voice interaction device, a smart home appliance, and a vehicle terminal. A text recognition-related client may be installed on the terminal device, and the client may be software (such as a browser or text recognition software), or a web page, an applet, or the like. The server 120 is a backend server corresponding to the software or web page, applet, or the like, or a server specifically configured to recognize text, which is not specifically defined in this application. The server 120 may be an independent physical server, or may be a server cluster or distributed system composed of a plurality of physical servers, or may be a cloud server that provides basic cloud computing services such as a cloud service, a cloud database, cloud computing, a cloud function, cloud storage, a network service, cloud communications, a middleware service, a domain name service, a security service, a content delivery network (CDN), and a big data and AI platform.

A text recognition method according to the embodiments of this application may be performed by an electronic device, and the electronic device may be the terminal device 110 or the server 120. That is, the method may be performed by the terminal device 110 or the server 120 alone, or may be performed joint by the terminal device 110 and the server 120.

For example, when the method is performed by the server 120, the server 120 performs at least one training iteration on a text recognition model to be trained based on a pre-constructed text sample set and a reference model, to obtain a trained text recognition model. Each text sample includes a sentence or paragraph of text, and the text contains at least one piece of mask information. In each training iteration, the server 120 inputs a text sample selected from the text sample set into the reference model and the text recognition model, respectively; obtains an output difference between each second transformer of the text recognition model and a corresponding target transformer of the reference model based on a transformer mapping relationship; and obtains a prediction difference between output layers of the text recognition model and the reference model for the mask information. Finally, the server 120 adjusts parameters of the text recognition model based on the output differences and the prediction difference. Finally, the trained text recognition model may be applied to a proper noun recognition scenario such as recognition of character names in text.

In another embodiment, the terminal device 110 communicates with the server 120 through a communication network.

In another embodiment, the communication network is a wired or wireless network.

FIG. 1 is only an example, and in practice, quantities of terminal devices and servers are not limited, which are not specifically defined in some embodiments of this application.

In some embodiments of this application, when there is a plurality of servers, the plurality of server may be grouped into a blockchain, and the servers are nodes on the blockchain. For example, training data, such as training samples, model parameters, and model outputs, involved in the text recognition method disclosed in some embodiments of this application may be stored on the blockchain.

In addition, the embodiments of this application are applicable to various scenarios, including but not limited to, a text recognition scenario, cloud technology, AI, intelligent transportation, assisted driving, and the like.

The following describes the text recognition method provided in embodiments of this application with reference to the foregoing application scenario and the drawings. The foregoing application scenario is illustrated to facilitate understanding of the spirit and principles of this application, and the embodiments of this application are not limited in this aspect.

FIG. 2 is a flowchart of an embodiment of a text recognition method according to an embodiment of this application. The method is performed by an electronic device, the electronic device may be the terminal device 110 or the server 120 shown in FIG. 1, and the specific embodiment of the method includes the following operations.

S201: Perform at least one training iteration on a text recognition model to be trained based on a pre-constructed text sample set and a reference model, to obtain a trained text recognition model.

In the foregoing operation, the reference model is configured to guide the text recognition model to be trained to perform imitation learning, namely, distillation training. The reference model is a trained model with a same application direction as the text recognition model to be trained, and may also be referred to as a teacher model.

The text recognition model to be trained learns text recognition by imitating the reference model, has a small scale and simple structure, and is applicable to a text recognition scenario, such as recognition of entity proper nouns, after being trained. In this application, the text recognition model to be trained may also be referred to as a student model.

In some embodiments of this application, the trained text recognition model may be configured to recognize a named entity in text to be recognized, to obtain text content corresponding to the named entity. A named entity refers to an entity in text that has specific meaning or specific reference, including a character name, a place, an institution, a date, a proper noun, and the like. For example, if the text recognition model to be trained is ultimately applied to recognition of geographical names in a paragraph of text, the reference model is a geographical location proper noun recognition model.

The model training method described in this application is not only applicable to the text recognition model, but also applicable to a text processing model, such as a text classification model or a text translation model, which is not defined in this application.

A description is made by taking the text classification model as an example. In subsequent operation S2014, it is necessary to adjust parameters based on a prediction difference between the text recognition model and the reference model for a text type of a text sample, or the text recognition model obtained in operation S2014 is further trained based on a text sample annotated with a real text type, to obtain the text classification model, or the like. The text translation model is obtained in a similar way, which is not defined here.

In addition, both the reference model and the text recognition model have a multi-layer structure. In some embodiments of this application, each layer includes one transformer. Each transformer includes two sub-layers, namely, a self-attention sub-layer and an FNN sub-layer. The quantity of transformers of the reference model is greater than that of transformers of the text recognition model, that is, the number of layers of the reference model is greater than that of layers of the text recognition model.

For example, both the reference model and the text recognition model to be trained in this application are bidirectional encoder representations from transformers (BERT). The BERT is a model with a transformer architecture. The transformer is a multilayer structure. During distillation training of the model, a technique of a mask language model (Mask LM), based on a mask mechanism, may be adopted for training. Therefore, a large-scale text corpus needs to be acquired as a text sample. The text sample herein may include a sentence or paragraph of text.

In some embodiments of this application, a specific method for constructing the text sample set includes: original text is segmented into a string sequence, some characters in the string sequence are masked, to obtain mask information of each masked character. Accordingly, each text sample contains a string sequence in which some characters are masked and at least one piece of mask information at a masked position. The text sample set is formed by all text samples.

For example, before inputting the text sample into the model, the server first segments the original text into a string sequence. Specifically, each character is referred to as a token, which serves as a basic unit of a model input. For original Chinese text, each Chinese character may be regarded as one token, and in this process, the original Chinese text is split into separate Chinese characters. For original English text, each word may be regarded as one token, and in this process, the original English text is split into separate words. By analogy, the same applies to other languages, which is not defined here.

In addition, the original text contains two special marker bits, namely, [CLS] and [September]. [CLS] is located at the beginning of the first sentence in the original text, and there is a [September] between two sentences in the original text. A string sequence may be obtained by concatenating [CLS] and at least one [September], which is also known as a token sequence.

Then, in the token sequence, some tokens are randomly masked, (for example, 15% of tokens are masked). Positions of these masked tokens are discontinuous or continuous. Each masked token corresponds to one piece of mask information at its position, that is, each text sample contains at least one piece of mask information. The mask information may be represented as a marker bit [mask] or [mask].

After the text sample set is constructed by the foregoing method, a text sample is selected from the text sample set, and at least one training iteration is performed on the reference model and the text recognition model to be trained by inputting the text sample. In this process, the reference model and the text recognition model predict the content of mask information in the text. This process enables the model to learn the meaning of the language itself, and learn connections between characters, between a character and a word, and between words. Through the guidance of the reference model, parameters of the text recognition model are continuously adjusted during distillation training. Then, the text recognition model subjected to distillation training may be applied to a specific scenario. A more specific text sample is selected according to the specific scenario for further fine adjustment of the trained text recognition model.

Because the model training method described in this application is not only applicable to the text recognition model, but also applicable to a text processing model, after distillation training is performed on the text recognition model based on the foregoing text sample containing the mask information, the text processing model subjected to distillation training may be applied to a specific scenario, or a more specific training sample is selected according to an actual application scenario of the text processing model and a specific processing task (such as text translation or text classification) for fine adjustment of parameters of the model.

In the foregoing operation, a specific embodiment of each training iteration includes S2011 to S2014.

S2011: Input a text sample selected from the text sample set into the reference model and the text recognition model, respectively.

As described above, both the reference model and the text recognition model to be trained may be BERT, and an encoding layer of the BERT includes a transformer. The reference model includes at least one first transformer configured to extract a feature, and the text recognition model includes at least one second transformer configured to extract a feature.

Each transformer includes two sub-layers, namely, a self-attention sub-layer and an FNN sub-layer. The self-attention sub-layer is configured to output a correlation degree of every two characters in the text sample, which may be specifically implemented as an attention mechanism in the BERT.

The FNN sub-layer adopts a unidirectional multilayer structure, which includes an input layer, at least one hidden layer, and an output layer. Each layer includes multiple neurons, and each neuron receives a signal from a previous neuron, and generates an output to the next layer. The FNN sub-layer performs forward transmission by taking an output of the self-attention sub-layer as an input, outputs a vector has a specified dimension, and transmits the vector to the next transformer.

The quantity of the first transformers of the reference model is greater than that of the second transformers of the text recognition model. For example, the quantity of the transformers of the reference model is m, the quantity of the second transformers of the text recognition model is n, and m>n.

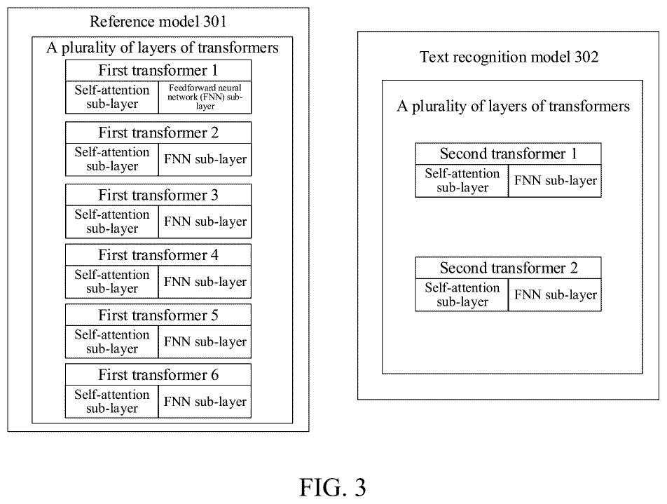

FIG. 3 is a schematic structural diagram of a reference model and a text recognition model according to an embodiment of this application. Both a reference model 301 and a text recognition model 302 are models based on transformer structures, which include a plurality of layers of transformers. Each layer corresponds to one transformer, and each transformer includes one self-attention sub-layer and one FNN sub-layer. The number of first transformers of the reference model 301 is greater. For example, as shown in FIG. 3, there are 6 first transformers in the reference model 301, and there are 2 second transformers in the text recognition model 302.

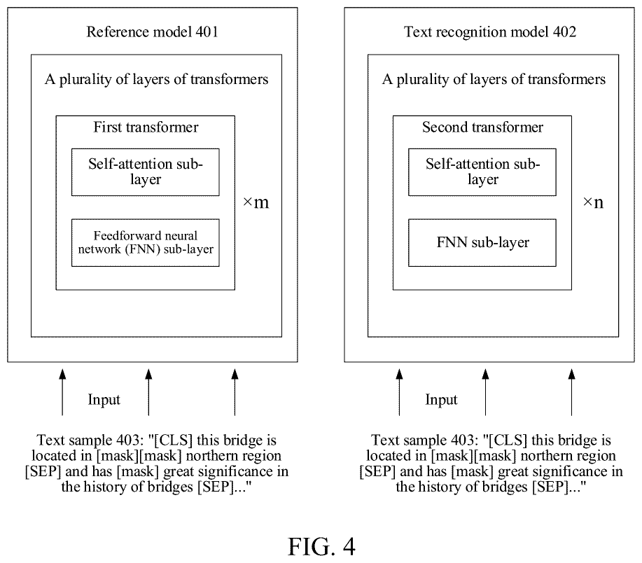

The following description takes a specific scenario as an example. A server selects a text sample from a text sample set, with the content of “[CLS] this bridge is located in [mask] [mask] northern region [September] and has [mask] great significance in the history of bridges [September] . . . ”, that is, three characters are masked. FIG. 4 is a schematic diagram of inputting a text sample into a model according to an embodiment of this application. The server inputs the foregoing text sample 403 into a reference model 401 and a text recognition model 402. The quantity of first transformers of the reference model 401 is m, a quantity of second transformers of the text recognition model 402 is n, and m>n.

S2012: Obtain an output difference between each second transformer and the corresponding first transformer of the reference model based on a transformer mapping relationship.

Because the quantity of the second transformers of the text recognition model is not equal to the quantity of the first transformers of the reference model, and the quantity of the first transformers of the reference model is greater than the quantity of the second transformers of the text recognition model, to achieve the correlation between the transformers, this application further introduces the transformer mapping relationship. The mapping relationship specifically indicates which first transformer of the reference model corresponds to each second transformer of the text recognition model, that is, the mapping relationship is a mapping relationship between each second transformer of the text recognition model and a particular first transformer of the reference model.

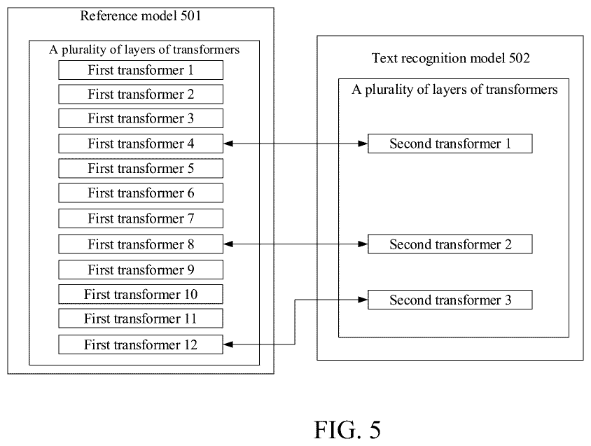

FIG. 5 is a schematic diagram of a transformer mapping relationship according to an embodiment of this application. In one embodiment, a one-to-one correspondence mapping method is adopted. For example, there are 3 second transformers (numbered 1 to 3) in a text recognition model 502, there are 12 first transformers (numbered 1 to 12) in a reference model 501, and a mapping relationship between the second transformers of the text recognition model 502 and the first transformers of the reference model 501 is that second transformer 1 corresponds to first transformer 4, second transformer 2 corresponds to first transformer 8, and second transformer 3 corresponds to first transformer 12.

Alternatively, several consecutive first transformers (the initial few or the final few first transformers) of the reference model are involved in mapping. For example, second transformer 1 corresponds to first transformer 1, second transformer 2 corresponds to first transformer 2, and second transformer 3 corresponds to first transformer 3, or second transformer 1 corresponds to first transformer 10, second transformer 2 corresponds to first transformer 11, and second transformer 3 corresponds to first transformer 12.

The transformer mapping methods described above are only examples, and any transformer mapping method can be adapted to the embodiments of this application, which will not be described one by one.

For the output difference, because each transformer includes a self-attention sub-layer and an FNN sub-layer, the output difference between the transformers includes two parts, namely, a first output difference corresponding to the self-attention sub-layer, and a second output difference corresponding to the FNN sub-layer.

In another embodiment, for each second transformer of the text recognition model, the following operations are performed to obtain the first output difference:
the first transformer, corresponding to the second transformer, of the reference model is determined as a target transformer based on the transformer mapping relationship; and
a difference between outputs of the self-attention sub-layer of the second transformer and the self-attention sub-layer of the target transformer is taken as the first output difference.

Further description is provided with reference to the aforementioned drawing. For example, first transformer 4 of the reference model is a target transformer corresponding to second transformer 1 of the text recognition model, first transformer 8 of the reference model is a target transformer corresponding to second transformer 2 of the text recognition model, and first transformer 12 of the reference model is a target transformer corresponding to second transformer 3 of the text recognition model.

Then, a degree of first correlation of every two characters in the text sample is obtained based on the self-attention sub-layer of the second transformer; and a degree of second correlation of every two characters in the text sample is obtained based on the self-attention sub-layer of the target transformer.

Finally, the first output difference is obtained based on a difference between the degree of first correlation and the degree of second correlation of every two characters.

From the perspective of learning (or distillation), the degree of first correlation outputted by the self-attention sub-layer of the text recognition model is configured for observation, and it may also be referred to as an degree of observation correlation. The degree of second correlation outputted by the self-attention sub-layer of the reference model is configured for comparison, and it may also be referred to as a degree of comparison correlation.

For example, the self-attention sub-layer of the second transformer of the text recognition model obtains a query matrix Q, a key matrix K, and a value matrix V based on each character in the inputted text sample, and further obtains the degree of first correlation of every two characters based on Q, K, and V.

Similarly, the self-attention sub-layer of the corresponding target transformer of the reference model obtains a query matrix Q, a key matrix K, and a value matrix V based on each character in the inputted text sample, and further obtains the degree of second correlation of every two characters based on Q, K, and V.

Finally, a sum of differences of squares of the degree of first correlations and the corresponding degree of second correlations is taken as the first output difference.

For example, A represents the reference model, B represents the text recognition model, and a specific formula for the first output difference is as follows:

$${Loss}_{att} = {\sum }_{i = 1}^{x} {\sum }_{j = 1}^{x} {( {α}_{i , j}^{A} - {α}_{i , j}^{B} )}^{2} \qquad ( 1 )$$

where, α_{i,j}^{A} indicates a degree of second correlation of an i^{th} character and a j^{th} character that is outputted by the reference model, α_{i,j}^{B} indicates a degree of first correlation of the i^{th} character and the j^{th} character that is outputted by the text recognition model, x indicates a length of tokens in the text sample, namely, a quantity of characters in text. In this distillation process, distillation is performed on both the mask information and other characters in the text sample that are not masked.

In the foregoing embodiment, the output of the self-attention sub-layer of the reference model is taken as supervision to train the text recognition model, whereby the text recognition model can fit an attention value of the reference model as much as possible. The attention value indicates a proportion of important information in text, which improves the accuracy of the text recognition model.

In another embodiment, for each second transformer of the text recognition model, the server performs the following operations to obtain the second output difference.

The difference between the outputs of the FNN sub-layer of the second transformer and the FNN sub-layer of the target transformer is taken as the second output difference.

For example, a first output vector of each character in the text sample is obtained based on the FNN sub-layer of the second transformer; a second output vector of each character in the text sample is obtained based on the FNN sub-layer of the target transformer; dimension transformation is performed on the first output vector of each character, to obtain a target vector having a same dimension as the second output vector of the character; and the second output difference is obtained based on differences between the target vectors and the second output vectors of the characters.

From the perspective of learning (or distillation), the first output vector outputted by the FNN sub-layer of the text recognition model may also be referred to as an observation vector, and the second output vector outputted by the FNN sub-layer of the reference model may also be referred to as a comparison vector.

The reason for dimension transformation is that the scale of the reference model is greater than that of the text recognition model, that is, the dimension of the reference model is greater than that of the text recognition model. This leads to a dimension difference between the first output vector of each character in the text sample that is obtained based on the text recognition model and the second output vector of each character in the text sample that is obtained based on the reference model. The dimension is determined by an output layer of the FNN sub-layer of the second transformer. Therefore, to align the dimension, dimension transformation is required.

A dimension transformation method includes: dimension transformation is performed on the first output vector of each character based on a pre-set parameter matrix and parameter vector, to obtain the target vector having the same dimension as the second output vector. The parameter matrix and the parameter vector are determined based on the dimension of the second output vector.

Specifically, a formula for aligning the dimensions of the first output vector and the second output vector is as follows:

$${V}^{′ B} = {W}_{proj} {V}^{B} + {b}_{1} \qquad ( 2 )$$

where, V^{B} indicates the first output vector, V′^{B} indicates the target vector having the same dimension as the second output vector, Wₚᵣₒⱼ indicates the parameter matrix, and b indicates the parameter vector.

Then, a sum of differences of squares of the target vectors and the corresponding second output vectors of the characters is taken as the second output difference.

For example, a specific formula for the second output difference is as follows:

$${Loss}_{f n n} = {\sum }_{i = 1}^{x} {\sum }_{d = 1}^{k} {( {V}_{d}^{A} - {V}_{d}^{′ B} )}^{2} \qquad ( 3 )$$

where, i indicates an i^{th} character in the text sample, x indicates a length of tokens in the text sample, namely, a quantity of characters in text, V_{d}^{A} is a d^{th} dimension of the second output vector, V′_{d}^{B} indicates a d^{th} dimension of the target vector, and k indicates the dimension of the reference model. In this distillation process, distillation is performed on all characters in the text sample.

In the foregoing embodiment, the output of the FNN sub-layer of the reference model is taken as supervision to train the text recognition model, whereby the text recognition model can fit the FNN sub-layer of the reference model as much as possible, and implement learning of the FNN, and the accuracy of the text recognition model is improved.

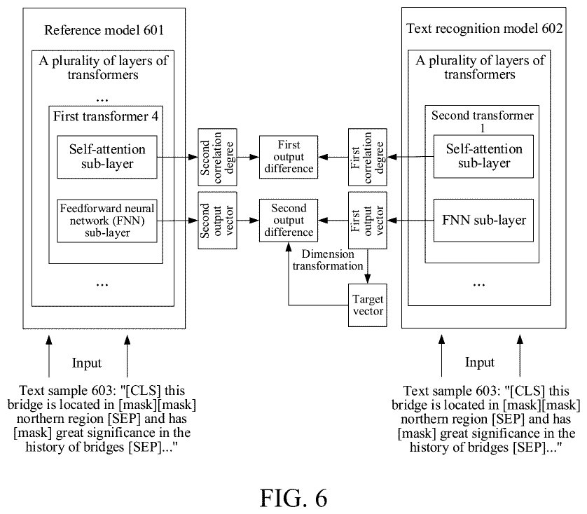

Following the assumptions in S2011, there are 3 second transformers in the text recognition model, and there are 12 first transformers in the reference model. The transformer mapping relationship is that second transformer 1 corresponds to first transformer 4, second transformer 2 corresponds to first transformer 8, and second transformer 3 corresponds to first transformer 12. FIG. 6 is a schematic logical diagram of acquisition of an output difference according to an embodiment of this application. After a text sample 603 with the content of “[CLS] this bridge is located in [mask] [mask] northern region [September] and has [mask] great significance in the history of bridges [September] . . . ” is inputted into a text recognition model 602 and a reference model 601, a self-attention sub-layer of second transformer 1 of the text recognition model 602 outputs a degree of first correlation of every two characters, a self-attention sub-layer of first transformer 4 of the reference model 601 outputs a degree of second correlation of every two characters, and the server calculates a sum of differences of squares of the degree of first correlations and the corresponding degree of second correlations, to obtain a first output difference.

An FNN sub-layer of second transformer 1 of the text recognition model 602 outputs a first output vector of each character in the text sample, an FNN sub-layer of first transformer 4 of the reference model outputs a second output vector of each character in the text sample, and the server performs dimension transformation on the first output vector, to obtain a target vector having a same dimension as the second output vector, and calculates a sum of differences of squares of the target vectors and the corresponding second output vectors, to obtain a second output difference.

Similarly, the server can further obtain a first output difference between a self-attention sub-layer of second transformer 2 of the text recognition model and a self-attention sub-layer of first transformer 8 of the reference model, and a first output difference between a self-attention sub-layer of second transformer 3 of the text recognition model and a self-attention sub-layer of first transformer 12 of the reference model. The servers can further obtain a second output difference between an FNN sub-layer of second transformer 2 of the text recognition model and an FNN sub-layer of first transformer 8 of the reference model, and a second output difference between an FNN sub-layer of second transformer 3 of the text recognition model and an FNN sub-layer of first transformer 12 of the reference model.

S2013: Obtain a prediction difference between the text recognition model and the reference model for mask information in the text sample.

Regarding the prediction difference, after the text sample is inputted into the text recognition model and the reference model, the text recognition model and the reference model predict each piece of mask information in the text sample, and output prediction results at output layers of the last transformers. Specifically, a first prediction result is outputted by an FNN sub-layer of the last second transformer of the text recognition model for each piece of mask information, a second prediction result is outputted by an FNN sub-layer of the corresponding target transformer of the reference model for each piece of mask information, and the prediction difference is obtained based on the prediction results outputted by the text recognition model and the prediction results outputted by the reference model.

In one embodiment, a first probability distribution corresponding to each first prediction result is acquired based on the first prediction result of the text recognition model for each piece of mask information; a second probability distribution corresponding to each second prediction result based on the second prediction result of the reference model for each piece of mask information; and finally, the prediction difference is obtained based on the first probability distributions and the second probability distributions.

From the perspective of learning (or distillation), the first probability distribution may also be referred to as an observation probability distribution; and the second probability distribution may also be referred to as a comparison probability distribution.

Specifically, for an output vector of one piece of mask information, namely, a prediction result Vₘₐₛₖ, the server performs linear transformation on the output vector according to the following formula, to generate a vector logits:

$$logits = {WV}_{mask} + {b}_{2} \qquad ( 4 )$$

where, W also indicates a parameter matrix, b₂ also indicates a parameter vector, W is not identical to Wₚᵣₒⱼ in formula (2) for dimension transformation, and b₂ is not identical to b₁.

The dimension of logits is the size of a pre-set word table, and is usually in the tens of thousands. The pre-set word table is constructed before training. A description is made by taking Chinese as an example, a basic component unit of the word table is a Chinese character, or in other words, the word table includes tens of thousands of Chinese characters, as well as identity documents (IDs) corresponding to each Chinese character. Because a machine cannot directly recognize text represented by a string, it is necessary to first digitize and vectorize characters in the text represented by the string. This process is based on the pre-set word table.

Similarly, if the language is English, the basic component unit of the word table is a separate word, or in other words, the word table includes a plurality of separate words and an ID corresponding to each separate word.

Then, the server transforms logits into a probability distribution according to a softmax function:

$$Probs = softmax ( logits ) \qquad ( 5 )$$

Probs indicates a probability distribution corresponding to the prediction result of one piece of mask information. The probability distribution includes a probability that the mask information predicted by the model is each basic component unit in the word table. If the word table is a Chinese character table, the probability distribution includes a probability that the mask information predicted by the model is each Chinese character in the word table.

The first probability distribution corresponding to the first prediction result outputted by the FNN sub-layer of the last second transformer of the text recognition model for each piece of mask information, and the second probability distribution corresponding to the second prediction result outputted by the FNN sub-layer of the corresponding target transformer of the reference model for each piece of mask information may be obtained according to the foregoing formula.

Finally, a sum of inverse numbers of relative entropies between the first probability distributions and the corresponding second probability distributions is taken as the prediction difference between the text recognition model and the reference model for the mask information. A specific formula is as follows:

$${Loss}_{mask} = {\sum }_{s = 1}^{g} - KL ( {Probs}_{B} ‖ {Probs}_{A} ) \qquad ( 6 )$$

$$KL ( {Probs}_{B} ‖ {Probs}_{A} ) = {\sum }_{y} {Probs}_{B} ( y ) log ( {Probs}_{B} ( y ) / {Probs}_{A} ( y ) ) \qquad ( 7 )$$

where, KL indicates a Kullback-Leibler divergence (KL divergence), namely, the relative entropy, and g indicates a quantity of the mask information in the text sample. s indicates s^{th} piece of mask information, y indicates all Chinese characters (or separate words) in the word table, and Probs_{B} indicates a probability that the mask information predicted by the text recognition model is each Chinese character (or each separate word) in the word table. Probs_{A} indicates a probability that the mask information predicted by the reference model is each Chinese character (or each separate word) in the word table. As shown in formula (7), during calculation of the KL divergence, the first probability distribution Probs_{B}(y) outputted by the text recognition model for each piece of mask information, and the second probability distribution Probs_{A}(y) outputted by the reference model for each piece of mask information are taken as inputs.

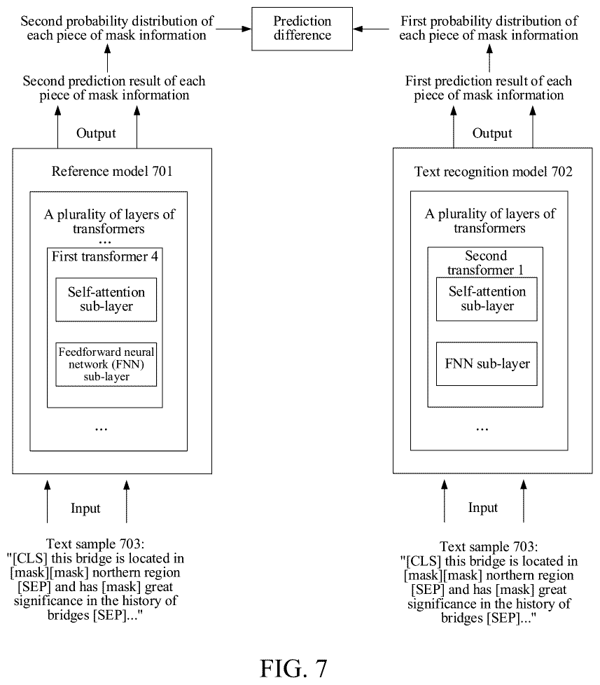

FIG. 7 is a schematic logical diagram of acquisition of a prediction difference according to an embodiment of this application. A text sample 703 with the content of “[CLS] this bridge is located in [mask] [mask] northern region [September] and has [mask] great significance in the history of bridges [September] . . . ” is inputted, and each “[mask]” corresponds to mask information s1, s2, s3, . . . , or sg. A text recognition model 702 predicts each piece of mask information, and outputs a first prediction result, and acquires a first probability distribution of each piece of mask information according to the first prediction result. A reference model 701 predicts each piece of mask information, outputs a second prediction result, and acquires a second probability distribution of each piece of mask information according to the second prediction result. Finally, a prediction difference between the text recognition model 702 and the reference model 701 for the text sample 703 is obtained based on the first probability distribution and the corresponding second probability distribution of each piece of mask information.

S2014: Adjust parameters of the text recognition model based on the output differences and the prediction difference.

Referring to the first output difference shown in formula (1), the second output difference shown in formula (3), and the prediction difference shown in formula (6). In another embodiment, weighted summation is performed on a sum of the first output differences, a sum of the second output differences, and the prediction difference based on pre-set coefficients, to obtain a target loss function; and the parameters of the text recognition model are adjusted based on the target loss function. The final loss function is calculated as follows:

$${Loss}_{a l l} = β \times {\sum }_{1}^{h} {Loss}_{att} + γ \times {\sum }_{1}^{h} {Loss}_{f n n} + \partial \times {Loss}_{mask} \qquad ( 8 )$$

where, h indicates a quantity of the second transformers of the text recognition model, and β, γ, and ∂ indicate the pre-set coefficients.

In the foregoing embodiment, the prediction result of the reference model for the mask information is taken as supervision to train the text recognition model, whereby the text recognition model can fit the output of the last layer of the reference model, and the accuracy of the text recognition model is improved.

In one embodiment, parameters of the parameter matrix and the parameter vector are adjusted based on the output differences and the prediction difference. That is, the parameter matrix, the parameter vector, and other parameters of the model are all adjusted.

In another embodiment of this application, in addition to the output differences and the prediction difference, a first probability distribution corresponding to each first prediction result is acquired based on the first prediction result of the text recognition model for each piece of mask information; and then the parameters of the text recognition model are adjusted based on a sum of inverse numbers of logarithms of the first probability distributions, the output differences, and the prediction difference.

That is, first, conventional training rather than distillation training is performed on the text recognition model, then, only the first probability distribution outputted by the text recognition model for each piece of mask information is acquired, a loss function Loss_{pred} is constructed based on the first probability distributions, and the reference model is not involved in this process. A specific formula is as follows:

$${Loss}_{pred} = {\sum }_{s = 1}^{g} - log ( {Probs}_{B} ) \qquad ( 9 )$$

where, g indicates a quantity of the mask information in the text sample. s indicates s^{th} piece of mask information.

Then, the server acquires the final loss function based on Loss_{pred}, Lossₐₜₜ, Loss_{fnn}, and Lossₘₐₛₖ, which is calculated as follows:

$${Loss}_{a l l} = {Loss}_{pred} + β \times {\sum }_{1}^{h} {Loss}_{att} + γ \times {\sum }_{1}^{h} {Loss}_{f n n} + \partial \times {Loss}_{mask} \qquad ( 10 )$$

where, h indicates a quantity of the second transformers of the text recognition model, and β, γ, and ∂ indicate the pre-set coefficients.

S202: Input text to be recognized into the trained text recognition model, and recognize a named entity in the text to be recognized, to obtain text content corresponding to the named entity.

Finally, the trained text recognition model obtained by the method in S201 can recognize a named entity in a paragraph of text.

It is assumed that the text recognition model is applied to a geographical location proper noun recognition scenario, text to be recognized is inputted into the trained text recognition model; feature extraction is performed on the text to be recognized based on the trained text recognition model, to obtain a text feature of the text to be recognized; and finally, a geographical location named entity in the text to be recognized is recognized based on the text feature, to obtain text content corresponding to the named entity.

Based on this, the text recognition method according to the embodiments of this application is applicable to a search scenario of a browser, instant messaging software, or a content sharing platform. For example, by recognizing and matching text inputted by an object and text in a content library, a more accurate search result can be recommended to the object, whereby the click-through rate of the content is further improved.

In addition, the model training method described in this application is applicable to another text processing model such as a text classification model or a text translation model. In a case of the text classification model, a trained text classification model is ultimately applied to a text classification scenario, the server inputs to-be-detected text into the trained text classification model; feature extraction is performed on the to-be-detected text based on the trained text classification model, to obtain a text feature of the to-be-detected text; and finally, a text type of the to-be-detected text is predicted based on the text feature, to obtain a corresponding prediction result.

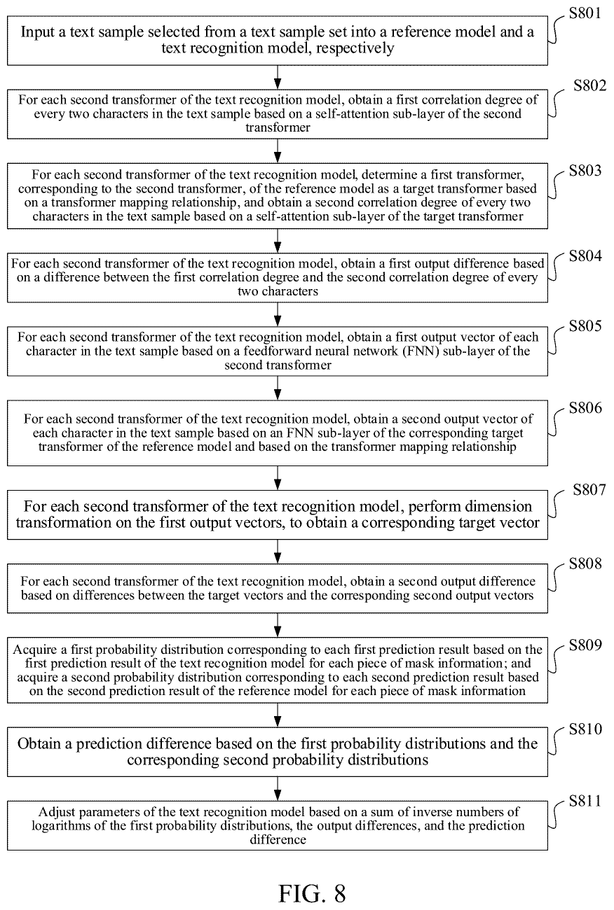

In another embodiment, FIG. 8 is a flowchart of another text recognition method according to an embodiment of this application, which is performed by an electronic device. The electronic device may be the terminal device 110 or the server 120 shown in FIG. 1, and the method includes the following operations.

S801: Input a text sample selected from a text sample set into a reference model and a text recognition model, respectively.

S802: For each second transformer of the text recognition model, obtain a degree of first correlation of every two characters in the text sample based on a self-attention sub-layer of the second transformer.

S803: For each second transformer of the text recognition model, determine a first transformer, corresponding to the second transformer, of the reference model as a target transformer based on a transformer mapping relationship, and obtain a degree of second correlation of every two characters in the text sample based on a self-attention sub-layer of the target transformer.

S804: For each second transformer of the text recognition model, obtain a first output difference based on a difference between the degree of first correlation and the degree of second correlation of every two characters.

In the foregoing operation, there is one first output difference between each second transformer of the text recognition model and the corresponding target transformer of the reference model, that is, a quantity of the first output differences is equal to that of the second transformers of the text recognition model.

S805: For each second transformer of the text recognition model, obtain a first output vector of each character in the text sample based on an FNN sub-layer of the second transformer.

S806: For each second transformer of the text recognition model, obtain a second output vector of each character in the text sample based on an FNN sub-layer of the corresponding target transformer of the reference model and based on the transformer mapping relationship.

S807: For each second transformer of the text recognition model, perform dimension transformation on the first output vectors, to obtain a corresponding target vector.

S808: For each second transformer of the text recognition model, obtain a second output difference based on differences between the target vectors and the corresponding second output vectors.

There is one second output difference between each second transformer of the text recognition model and the corresponding target transformer of the reference model, that is, a quantity of the second output differences is equal to that of the second transformers of the text recognition model.

S809: Acquire a first probability distribution corresponding to each first prediction result based on the first prediction result of the text recognition model for each piece of mask information; and acquire a second probability distribution corresponding to each second prediction result based on the second prediction result of the reference model for each piece of mask information.

S810: Obtain a prediction difference based on the first probability distributions and the corresponding second probability distributions.

S811: Adjust parameters of the text recognition model based on a sum of inverse numbers of logarithms of the first probability distributions, the output differences, and the prediction difference.

The output differences include a sum of all first output differences, and a sum of all second output differences.

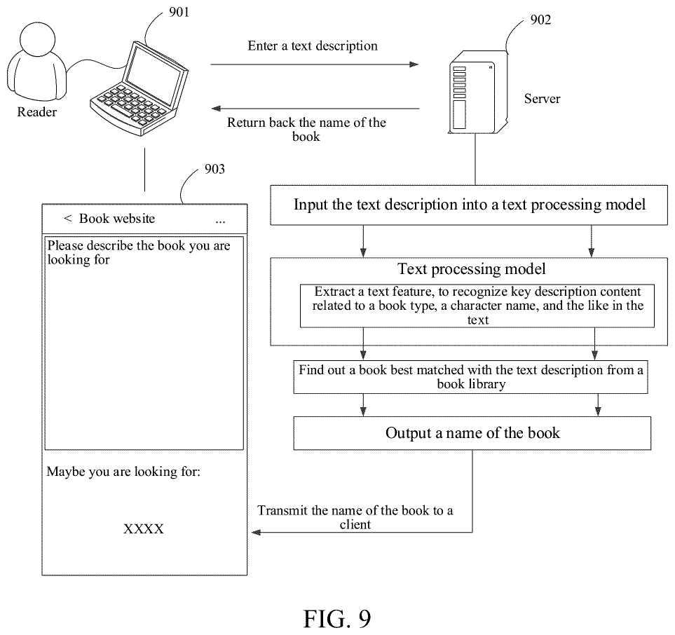

FIG. 9 is a logical diagram of an interaction between a terminal device and a server when a text recognition model is applied according to an embodiment of this application. It is assumed that the text recognition model is applied to a scenario that a book website allows a reader to search for a corresponding book according to described specific plot and book type, prompt information “Please describe the book you are looking for” is displayed on an interface 903 of the book website, after the reader enters a text description on a terminal device 901, and a server 902 inputs the text description into the text recognition model. The text recognition model extracts a text feature, and recognizes key description content related to a book type, a character name, and the like in the text. Then, the server 902 compares the key description content to original introductions to various books in a book library, and finds out a book best matched with the text description, that is, finds out a book corresponding to the best matched book introduction, outputs a name of the book, and transmits the name of the book back to the terminal device 901. Search result information “Maybe you are looking for XXXX” is displayed on the interface 903 of the book website.

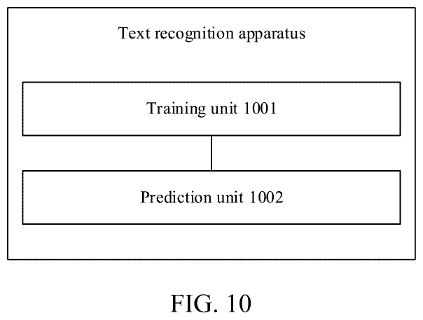

Based on the same inventive concept, embodiments of this application further provide a text recognition apparatus. FIG. 10 is a schematic structural diagram of a text recognition apparatus. The text recognition apparatus may include:
a training unit 1001, configured to perform at least one training iteration on a text recognition model to be trained based on a pre-constructed text sample set and a reference model, to obtain a trained text recognition model; and
a prediction unit 1002, configured to input text to be recognized into the trained text recognition model, and recognize a named entity in the text to be recognized, to obtain text content corresponding to the named entity.

The training unit 1001 includes: an input sub-unit 10011, an acquisition sub-unit 10012, and an adjustment sub-unit 10013, which are configured to perform the following operations in each training iteration.

The input sub-unit 10011 is configured to in each training iteration, input a text sample selected from the text sample set into the reference model and the text recognition model, respectively, the reference model including at least one first transformer configured to extract a feature, the text recognition model including at least one second transformer configured to extract a feature, and a quantity of the first transformers being greater than that of the second transformers.

The acquisition sub-unit 10012 is configured to in each training iteration, obtain an output difference between each second transformer and the corresponding first transformer of the reference model based on a transformer mapping relationship; and obtain a prediction difference between the text recognition model and the reference model for mask information in the text sample.

The adjustment sub-unit 10013 is configured to in each training iteration, adjust parameters of the text recognition model based on the output differences and the prediction difference.

In an embodiment, each transformer includes a self-attention sub-layer and an FNN sub-layer, and the transformer mapping relationship indicates a mapping relationship between each transformer of the text recognition model and a particular transformer of the reference model; and the output difference includes a first output difference corresponding to the self-attention sub-layer, and a second output difference corresponding to the FNN sub-layer. For each second transformer of the text recognition model, the acquisition sub-unit 10012 is specifically configured to:
determine the first transformer, corresponding to the second transformer, of the reference model as a target transformer based on the transformer mapping relationship;
take a difference between outputs of the self-attention sub-layer of the second transformer and the self-attention sub-layer of the target transformer as the first output difference; and
take a difference between outputs of the FNN sub-layer of the second transformer and the FNN sub-layer of the target transformer as the second output difference.

In an embodiment, the acquisition sub-unit 10012 is specifically configured to:
obtain a degree of first correlation of every two characters in the text sample based on the self-attention sub-layer of the second transformer;
obtain a degree of second correlation of every two characters in the text sample based on the self-attention sub-layer of the target transformer; and
obtain the first output difference based on a difference between the degree of first correlation and the degree of second correlation of every two characters.

In an embodiment, the acquisition sub-unit 10012 is specifically configured to: take a sum of differences of squares of the degree of first correlations and the corresponding degree of second correlations as the first output difference.

In an embodiment, the acquisition sub-unit 10012 is specifically configured to:
obtain a first output vector of each character in the text sample based on the FNN sub-layer of the second transformer;
obtain a second output vector of each character in the text sample based on the FNN sub-layer of the target transformer;
perform dimension transformation on the first output vector of each character, to obtain a target vector having the same dimension as the second output vector of the character; and
obtain the second output difference based on differences between the target vectors and the second output vectors of the characters.

In an embodiment, the acquisition sub-unit 10012 is specifically configured to:
perform dimension transformation on the first output vector based on a pre-set parameter matrix and parameter vector, to obtain the target vector, the parameter matrix and the parameter vector being determined based on the dimension of the second output vector.

The adjustment sub-unit 10013 is further configured to:
adjust parameters of the parameter matrix and the parameter vector based on the output differences and the prediction difference.

In an embodiment, the acquisition sub-unit 10012 is specifically configured to:
take a sum of differences of squares of the target vectors and the corresponding second output vectors as the second output difference.

In an embodiment, the acquisition sub-unit 10012 is specifically configured to:
acquire a first probability distribution corresponding to each first prediction result based on the first prediction result of the text recognition model for each piece of mask information in the text sample;
acquire a second probability distribution corresponding to each second prediction result based on the second prediction result of the reference model for each piece of mask information in the text sample; and
obtain the prediction difference based on the first probability distributions and the corresponding second probability distributions.

In an embodiment, the acquisition sub-unit 10012 is specifically configured to:
take a sum of inverse numbers of relative entropies between the first probability distributions and the corresponding second probability distributions as the prediction difference.

In an embodiment, the adjustment sub-unit 10013 is specifically configured to:
perform weighted summation on a sum of the first output differences, a sum of the second output differences, and the prediction difference based on pre-set coefficients, to obtain a target loss function; and
adjust the parameters of the text recognition model based on the target loss function.

In an embodiment, the acquisition sub-unit 10012 is further configured to:
acquire a first probability distribution corresponding to each first prediction result based on the first prediction result of the text recognition model for each piece of mask information.

The adjustment sub-unit 10013 is specifically configured to:
adjust the parameters of the text recognition model based on a sum of inverse numbers of logarithms of the first probability distributions, the output differences, and the prediction difference.

In an embodiment, the prediction unit 1002 is specifically configured to:
perform feature extraction on the text to be recognized based on the trained text recognition model, to obtain a text feature of the text to be recognized; and
recognize the named entity in the text to be recognized based on the text feature, to obtain the text content corresponding to the named entity.

For ease of description, the foregoing parts are divided into modules (or units) according to their functions and described separately. During embodiment of this application, the functions of the modules (or units) may be implemented in the same or a plurality of software or hardware.

After the text recognition method and apparatus according to the embodiments of this application are introduced, next, an electronic device according to another embodiment of this application is introduced.

Those skilled in the art may understand that the aspects of this application may be implemented as a system, a method, or a program product. Therefore, the aspects of this application may be specifically implemented in the following form, that is, a complete hardware embodiment, a complete software embodiment (including firmware, microcode, and the like), or an embodiment that combines hardware and software aspects, which may be collectively referred to herein as a “circuit”, “module”, or “system”.

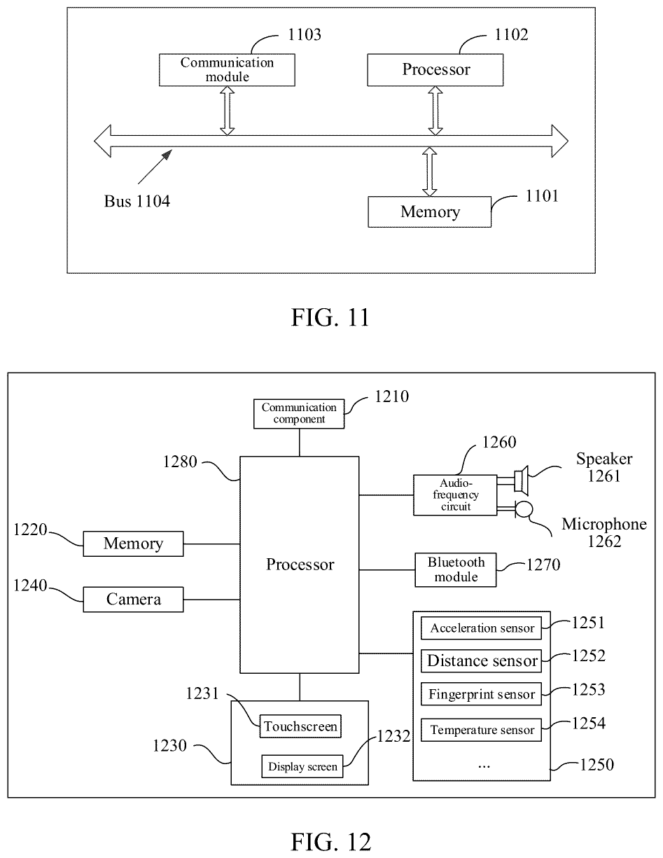

Based on the same inventive concept as the foregoing method embodiments, embodiments of this application further provide an electronic device. In an embodiment, the electronic device may be a server, such as the server 120 shown in FIG. 1. In this embodiment, the electronic device has a structure shown in FIG. 11, and includes a memory 1101, a communication module 1103, and one or more processors 1102.

The memory 1101 is configured to store a computer program executed by the processor 1102. The memory 1101 may mainly include a program storage area and a data storage area. The program storage area may store an operating system, programs required for running instant messaging functions, and the like. The data storage area may store instant messaging information, operating instruction sets, and the like.

The memory 1101 may be a volatile memory such as a random-access memory (RAM); or may be a non-volatile memory such as a read-only memory, a flash memory, a hard disk drive (HDD), or a solid-state drive (SSD); or may be any other medium capable of carrying or storing a desired computer program in the form of instructions or data structures and capable of being accessed by a computer, but is not limited thereto. The memory 1101 may be a combination of the foregoing memories.

The processor 1102 may include one or more central processing units (CPUs), digital processing units, or the like. The processor 1102 is configured to invoke the computer program stored in the memory 1101 to implement the foregoing text recognition method.

The communication module 1103 is configured to implement communication with a terminal device and another server.

A specific connection medium among the memory 1101, the communication module 1103, and the processor 1102 is not defined in some embodiments of this application. In some embodiments of this application, as shown in FIG. 11, the memory 1101 is connected to the processor 1102 via a bus 1104, which is indicated by a thick line in FIG. 11. The connection methods between other components are merely illustrative and are not intended to be limiting. The bus 1104 may be divided into an address bus, a data bus, a control bus, and the like. For ease of description, the bus is indicated by only one thick line in FIG. 11, which does not indicate that there is only one bus or one type of bus.

The memory 1101 has a computer storage medium stored therein, the computer storage medium has computer-executable instructions stored therein, and the computer-executable instructions are configured to implement the text recognition method according to the embodiments of this application. The processor 1102 is configured to perform the foregoing text recognition method, as shown in FIG. 2.

In another embodiment, the electronic device may be another electronic device such as the terminal device 110 shown in FIG. 1. In this embodiment, the electronic device has a structure shown in FIG. 12, and includes: a communication component 1210, a memory 1220, a display unit 1230, a camera 1240, a sensor 1250, an audio-frequency circuit 1260, a Bluetooth module 1270, a processor 1280, and another component.

The communication component 1210 is configured to implement communication with a server. In some embodiments, the electronic device includes a Wireless Fidelity (WiFi) module. The WiFi module belongs to short-range wireless transmission technology. The electronic device can help an object (such as a user) transmit and receive information through WiFi module.

The memory 1220 may be configured to store a software program and data. The processor 1280 runs the software program or data stored in the memory 1220, to implement various functions of the terminal device 110 and data processing. The memory 1220 may include a high-speed RAM, and may further include a non-volatile memory, such as at least one disk storage device, a flash storage device, or another volatile solid-state storage device. The memory 1220 stores an operating system that enables the terminal device 110 to operate. In this application, the memory 1220 may store the operating system and various application programs, and may further store a computer program configured to perform the text recognition method according to the embodiments of this application.

The display unit 1230 may be configured to display information inputted by the object or provide information and a graphical user interface (GUI) of various menus of the terminal device 110 to the object. Specifically, the display unit 1230 may include a display screen 1232 arranged on a front surface of the terminal device 110. The display screen 1232 may be implemented in the form of a liquid crystal display, a light-emitting diode, or the like. The display unit 1230 may be configured to display an interface of text recognition according to the embodiments of this application, and the like.

The display unit 1230 may further be configured to receive inputted digital or character information, and generate a signal input related to the object setting and function control of the terminal device 110. Specifically, the display unit 1230 may include a touchscreen 1231 arranged on the front surface of the terminal device 110, which can collect touch operations of the object on or near the touch screen, such as clicking a button and dragging a scroll box.

The touchscreen 1231 may cover the display screen 1232, or the touchscreen 1231 and the display screen 1232 may be integrated to implement the input and output functions of the terminal device 110. A component formed by integrating the touchscreen and the display screen may be referred to as a touch display screen. In this application, the display unit 1230 can display an application program and corresponding operations.

The camera 1240 may be configured to capture a static image, and the object may publish the image captured by the camera 1240 through an application. There may be one or more cameras 1240. An object is captured by a lens to generate an optical image, and the optical image is projected to a photosensitive element. The photosensitive element may be a charge-coupled device (CCD) or a complementary metal-oxide-semiconductor (CMOS) phototransistor. The photosensitive element converts the optical signal into an electric signal, and then transfers the electric signal to the processor 1280 for conversion into a digital image signal.

The terminal device may further include at least one sensor 1250, such as an acceleration sensor 1251, a distance sensor 1252, a fingerprint sensor 1253, and a temperature sensor 1254. The terminal device may further be provided with other sensors such as a gyroscope, a barometer, a hygrometer, a thermometer, an infrared sensor, an optical sensor, and a motion sensor.

The audio-frequency circuit 1260, a speaker 1261, and a microphone 1262 may provide audio interfaces between a user and the terminal device 110. The audio-frequency circuit 1260 may convert received audio data into an electric signal and transmit the electric signal to the speaker 1261. The speaker 1261 converts the electric signal into a sound signal and outputs the sound signal. The terminal device 110 may further be provided with a volume button configured to adjust volume of a sound signal. In addition, the microphone 1262 converts a collected sound signal into an electric signal. The audio-frequency circuit 1260 receives the electric signal, converts the electric signal into audio data, and outputs the audio data to the communication component 1210 for transmitting the audio data to another terminal device 110, or outputs the audio data to the memory 1220 for further processing.

The Bluetooth module 1270 is configured to perform information exchange with another Bluetooth device having a Bluetooth module by using a Bluetooth protocol. For example, the terminal device may establish, by using the Bluetooth module 1270, a Bluetooth connection with a wearable electronic device (such as a smartwatch) also having a Bluetooth module, to exchange data.

The processor 1280 is a control center of the terminal device, and is connected to various parts of the entire terminal device via various interfaces and circuits. The processor implements various functions of the terminal device and data processing by running or executing the software program stored in the memory 1220 and invoking the data stored in the memory 1220. In some embodiments, the processor 1280 may include one or more processing units. An application processor and a baseband processor may be integrated into the processor 1280. The application processor mainly processes the operating system, a user interface, an application, and the like, and the baseband processor mainly processes wireless communication. The foregoing baseband processor may either not be integrated into the processor 1280. In this application, the processor 1280 may run the operating system, the application program, object interface display, and a touch response, and the text recognition method according to the embodiments of this application. In addition, the processor 1280 is coupled to the display unit 1230.

In some embodiments, the aspects of the text recognition method provided in this application are implemented in the form of a program product, which includes a computer program. When the program product runs an electronic device, the computer program is configured to enable the electronic device to perform the operations of the text recognition method according to the foregoing embodiments of this application. For example, the electronic device performs the operations shown in FIG. 2.

The program product may be any combination of one or more readable media. The readable medium may be a readable signal medium or a readable storage medium. The readable storage medium may be, for example, but is not limited to, an electric, magnetic, optical, electromagnetic, infrared, or semi-conductive system, apparatus, or device, or any combination thereof. More specific examples (a non-exhaustive list) of the readable storage medium include: an electrical connection having one or more wires, a portable disk, a hard disk, an RAM, an ROM, an erasable programmable ROM (EPROM or a flash memory), an optical fiber, a compact disc ROM (CD-ROM), an optical storage device, a magnetic storage device, or any appropriate combination thereof.

The program product according to the embodiments of this application may adopt a CD-ROM and include a computer program, and may be run on an electronic device. However, the program product of this application is not limited thereto. Here, the readable storage medium may be any tangible medium including or storing a program used by or in combination with an instruction execution system, apparatus, or device.

The readable signal medium may include a data signal in a baseband or propagated as a part of a carrier, which carries a readable computer program. Such a propagated data signal may take a variety of forms, including but not limited to an electromagnetic signal, an optical signal, or any appropriate combination thereof. The readable storage medium may alternatively be any readable medium other than a readable storage medium, and may transmit, propagate, or transfer a program used by or in combination with an instruction execution system, apparatus, or device.

The computer program included in the readable medium may be transferred by using any suitable medium, including but not limited to a wireless or a wired medium, an optical cable, a radio frequency (RF), and the like, or any combination thereof.

The computer program configured to perform the operations of this application may be written by using one or more programming languages or any combination thereof. The programming languages include an object-oriented programming language such as Java and C++, and also include a conventional procedural programming language such as “C” or similar programming languages. The computer program may be completely executed on an object electronic device, partially executed on the object electronic device, executed as an independent software package, partially executed on the object electronic device and partially executed on a remote electronic device, or completely executed on the remote electronic device or a server. In cases involving the remote electronic device, the remote electronic device may be connected to the object electronic device through any type of network including a local area network (LAN) or a wide area network (WAN), or may be connected to an external electronic device (for example, through the Internet by using an Internet service provider).

Although several units or sub-units of an apparatus are described above in detail, the division is only illustrative not mandatory. Actually, according to the embodiments of this application, the features and functions of two or more units described above may be specifically implemented in one unit. On the contrary, the features and functions of one unit described above may further be divided to be embodied by a plurality of units.

In addition, although the operations of the method of this application are described in a specific order in the accompanying drawings, this does not require or imply that these operations are bound to be performed in the specific order, or all the operations shown are bound to be performed to achieve the expected result. Additionally or alternatively, some operations may be omitted, a plurality of operations may be combined into one operation for execution, and/or one operation may be decomposed into a plurality of operations for execution.

Those skilled in the art may understand that the embodiments of this application may be provided as a method, a system, or a computer program product. Therefore, this application may adopt a form of complete hardware embodiments, complete software embodiments, or embodiments combining software and hardware. Moreover, this application may adopt a form of a computer program product that is implemented on one or more computer-usable storage media (including but not limited to a disk memory, a CD-ROM, an optical memory, and the like) that include computer-usable computer programs.

This application is described with reference to the flowcharts and/or block diagrams of the method, the device (system), and the computer program product according to the embodiments of this application. Computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, whereby an apparatus configured to implement functions specified in one or more procedures in the flowcharts and/or one or more blocks in the block diagrams is generated by using the instructions executed by the computer or the processor of another programmable data processing device.

These computer program instructions may alternatively be stored in a computer-readable memory that can instruct the computer or another programmable data processing device to work in a specific manner, whereby the instructions stored in the computer-readable memory generate an artifact that includes an instruction apparatus. The instruction apparatus implements functions specified in one or more procedures in the flowcharts and/or in one or more blocks in the block diagrams.

These computer program instructions may alternatively be loaded onto the computer or another programmable data processing device, whereby a series of operations are performed on the computer or another programmable device, to generate computer-implemented processing. Therefore, the instructions executed on the computer or another programmable device provide operations for implementing functions specified in one or more procedures in the flowcharts and/or in one or more blocks in the block diagrams.

Although embodiments of this application have been described, once those skilled in the art know the basic creative concept, they can make additional changes and modifications to these embodiments. Therefore, the appended claims are intended to be construed as to cover the embodiments and all changes and modifications falling within the scope of this application.

Apparently, those skilled in the art may make various modifications and variations to this application without departing from the spirit and scope of this application. In this case, if the modifications and variations made to this application fall within the scope of the claims of this application and their equivalent technologies, this application is intended to include these modifications and variations.

What is claimed is:

1. A text recognition method, performed by an electronic device and comprising:
performing at least one training iteration on a text recognition model to be trained based on a pre-constructed text sample set and a reference model, to obtain a trained text recognition model; and
inputting text to be recognized into the trained text recognition model, and recognizing a named entity in the text to be recognized, to obtain text content corresponding to the named entity,
wherein each training iteration comprises:
respectively inputting a text sample selected from the text sample set into the reference model and the text recognition model, the reference model comprising at least one first transformer configured to extract a feature, the text recognition model comprising at least one second transformer configured to extract a feature;
obtaining an output difference between each second transformer and the corresponding first transformer of the reference model based on a transformer mapping relationship;
obtaining a prediction difference between the text recognition model and the reference model for mask information in the text sample; and
adjusting parameters of the text recognition model based on the output differences and the prediction difference.

2. The method according to claim 1, wherein and a quantity of the first transformers being greater than that of the second transformers, and each transformer comprises a self-attention sub-layer and a feedforward neural network (FNN) sub-layer, and the transformer mapping relationship is a mapping relationship between each second transformer of the text recognition model and a first transformer of the reference model; and the output difference comprises a first output difference corresponding to the self-attention sub-layer, and a second output difference corresponding to the FNN sub-layer; and
the obtaining an output difference between each second transformer and the corresponding first transformer of the reference model based on a transformer mapping relationship comprises performing the following operations for each second transformer of the text recognition model:
determining the first transformer, corresponding to the second transformer, of the reference model as a target transformer based on the transformer mapping relationship;
taking a difference between outputs of the self-attention sub-layer of the second transformer and the self-attention sub-layer of the target transformer as the first output difference; and
taking a difference between outputs of the FNN sub-layer of the second transformer and the FNN sub-layer of the target transformer as the second output difference.

3. The method according to claim 2, wherein the taking a difference between outputs of the self-attention sub-layer of the second transformer and the self-attention sub-layer of the target transformer as the first output difference comprises:
obtaining a degree of first correlation of every two characters in the text sample based on the self-attention sub-layer of the second transformer;
obtaining a degree of second correlation of every two characters in the text sample based on the self-attention sub-layer of the target transformer; and
obtaining the first output difference based on a difference between the degree of first correlation and the degree of second correlation of every two characters.

4. The method according to claim 3, wherein the obtaining the first output difference based on a difference between the degree of first correlation and the degree of second correlation of every two characters comprises:
taking a sum of differences of squares of the degree of first correlations and the corresponding degree of second correlations as the first output difference.

5. The method according to claim 2, wherein the taking a difference between outputs of the FNN sub-layer of the second transformer and the FNN sub-layer of the target transformer as the second output difference comprises:
obtaining a first output vector of each character in the text sample based on the FNN sub-layer of the second transformer;
obtaining a second output vector of each character in the text sample based on the FNN sub-layer of the target transformer;
performing dimension transformation on the first output vector of each character, to obtain a target vector having a same dimension as the second output vector of the character; and
obtaining the second output difference based on differences between the target vectors and the second output vectors of the characters.

6. The method according to claim 5, wherein the performing dimension transformation on the first output vector of each character, to obtain a target vector having a same dimension as the second output vector of the character comprises:
performing dimension transformation on the first output vector based on a pre-set parameter matrix and parameter vector, to obtain the target vector, the parameter matrix and the parameter vector being determined based on the dimension of the second output vector; and
the method further comprises:
adjusting parameters of the parameter matrix and the parameter vector based on the output differences and the prediction difference.

7. The method according to claim 5, wherein the obtaining the second output difference based on the differences between the target vectors and the second output vectors of the characters comprises:
taking a sum of differences of squares of the target vectors and the corresponding second output vectors as the second output difference.

8. The method according to claim 1, wherein the obtaining a prediction difference between the text recognition model and the reference model for mask information in the text sample comprises:
acquiring a first probability distribution corresponding to each first prediction result based on the first prediction result of the text recognition model for each piece of mask information in the text sample;
acquiring a second probability distribution corresponding to each second prediction result based on the second prediction result of the reference model for each piece of mask information in the text sample; and
obtaining the prediction difference based on the first probability distributions and the corresponding second probability distributions.

9. The method according to claim 8, wherein the obtaining the prediction difference based on the first probability distributions and the corresponding second probability distributions comprises:
taking a sum of inverse numbers of relative entropies between the first probability distributions and the corresponding second probability distributions as the prediction difference.

10. The method according to claim 2, wherein the adjusting parameters of the text recognition model based on the output differences and the prediction difference comprises:
performing weighted summation on a sum of the first output differences, a sum of the second output differences, and the prediction difference based on pre-set coefficients, to obtain a target loss function; and
adjusting the parameters of the text recognition model based on the target loss function.

11. The method according to claim 1, further comprising:
acquiring a first probability distribution corresponding to each first prediction result based on the first prediction result of the text recognition model for each piece of mask information, the adjusting parameters of the text recognition model based on the output differences and the prediction difference comprising:
adjusting the parameters of the text recognition model based on a sum of inverse numbers of logarithms of the first probability distributions, the output differences, and the prediction difference.

12. The method according to claim 1, wherein the inputting text to be recognized into the trained text recognition model, and recognizing a named entity in the text to be recognized, to obtain text content corresponding to the named entity comprises:
performing feature extraction on the text to be recognized based on the trained text recognition model, to obtain a text feature of the text to be recognized; and
recognizing the named entity in the text to be recognized based on the text feature, to obtain the text content corresponding to the named entity.

13. An electronic device, comprising a processor and a memory, the memory having a computer program stored therein, and the processor, when executing the computer program, performing the operations of a text recognition method, performed by an electronic device and comprising:
performing at least one training iteration on a text recognition model to be trained based on a pre-constructed text sample set and a reference model, to obtain a trained text recognition model; and
inputting text to be recognized into the trained text recognition model, and recognizing a named entity in the text to be recognized, to obtain text content corresponding to the named entity,
wherein each training iteration comprising:
respectively inputting a text sample selected from the text sample set into the reference model and the text recognition model, the reference model comprising at least one first transformer configured to extract a feature, the text recognition model comprising at least one second transformer configured to extract a feature;
obtaining an output difference between each second transformer and the corresponding first transformer of the reference model based on a transformer mapping relationship;
obtaining a prediction difference between the text recognition model and the reference model for mask information in the text sample; and
adjusting parameters of the text recognition model based on the output differences and the prediction difference.

14. The electronic device according to claim 13, wherein and a quantity of the first transformers being greater than that of the second transformers and each transformer comprises a self-attention sub-layer and a feedforward neural network (FNN) sub-layer, and the transformer mapping relationship is a mapping relationship between each second transformer of the text recognition model and a first transformer of the reference model; and the output difference comprises a first output difference corresponding to the self-attention sub-layer, and a second output difference corresponding to the FNN sub-layer; and
the obtaining an output difference between each second transformer and the corresponding first transformer of the reference model based on a transformer mapping relationship comprises performing the following operations for each second transformer of the text recognition model:
determining the first transformer, corresponding to the second transformer, of the reference model as a target transformer based on the transformer mapping relationship;
taking a difference between outputs of the self-attention sub-layer of the second transformer and the self-attention sub-layer of the target transformer as the first output difference; and
taking a difference between outputs of the FNN sub-layer of the second transformer and the FNN sub-layer of the target transformer as the second output difference.

15. The electronic device according to claim 14, wherein the taking a difference between outputs of the self-attention sub-layer of the second transformer and the self-attention sub-layer of the target transformer as the first output difference comprises:
obtaining a degree of first correlation of every two characters in the text sample based on the self-attention sub-layer of the second transformer;
obtaining a degree of second correlation of every two characters in the text sample based on the self-attention sub-layer of the target transformer; and
obtaining the first output difference based on a difference between the degree of first correlation and the degree of second correlation of every two characters.

16. The electronic device according to claim 15, wherein the obtaining the first output difference based on a difference between the degree of first correlation and the degree of second correlation of every two characters comprises:
taking a sum of differences of squares of the degree of first correlations and the corresponding degree of second correlations as the first output difference.

17. The electronic device according to claim 14, wherein the taking a difference between outputs of the FNN sub-layer of the second transformer and the FNN sub-layer of the target transformer as the second output difference comprises:
obtaining a first output vector of each character in the text sample based on the FNN sub-layer of the second transformer;
obtaining a second output vector of each character in the text sample based on the FNN sub-layer of the target transformer;
performing dimension transformation on the first output vector of each character, to obtain a target vector having a same dimension as the second output vector of the character; and
obtaining the second output difference based on differences between the target vectors and the second output vectors of the characters.

18. A non-transitory computer-readable storage medium, comprising a computer program that, when running on an electronic device, causes the electronic device to perform the operations of a text recognition method, performed by an electronic device and comprising:
performing at least one training iteration on a text recognition model to be trained based on a pre-constructed text sample set and a reference model, to obtain a trained text recognition model; and
inputting text to be recognized into the trained text recognition model, and recognizing a named entity in the text to be recognized, to obtain text content corresponding to the named entity,
wherein each training iteration comprising:
respectively inputting a text sample selected from the text sample set into the reference model and the text recognition model, the reference model comprising at least one first transformer configured to extract a feature, the text recognition model comprising at least one second transformer configured to extract a feature;
obtaining an output difference between each second transformer and the corresponding first transformer of the reference model based on a transformer mapping relationship;
obtaining a prediction difference between the text recognition model and the reference model for mask information in the text sample; and
adjusting parameters of the text recognition model based on the output differences and the prediction difference.

19. The computer-readable storage medium according to claim 18, wherein a quantity of the first transformers being greater than that of the second transformers and each transformer comprises a self-attention sub-layer and a feedforward neural network (FNN) sub-layer, and the transformer mapping relationship is a mapping relationship between each second transformer of the text recognition model and a first transformer of the reference model; and the output difference comprises a first output difference corresponding to the self-attention sub-layer, and a second output difference corresponding to the FNN sub-layer; and
the obtaining an output difference between each second transformer and the corresponding first transformer of the reference model based on a transformer mapping relationship comprises performing the following operations for each second transformer of the text recognition model:
determining the first transformer, corresponding to the second transformer, of the reference model as a target transformer based on the transformer mapping relationship;
taking a difference between outputs of the self-attention sub-layer of the second transformer and the self-attention sub-layer of the target transformer as the first output difference; and
taking a difference between outputs of the FNN sub-layer of the second transformer and the FNN sub-layer of the target transformer as the second output difference.

20. The computer-readable storage medium according to claim 19, wherein the taking a difference between outputs of the self-attention sub-layer of the second transformer and the self-attention sub-layer of the target transformer as the first output difference comprises:
obtaining a degree of first correlation of every two characters in the text sample based on the self-attention sub-layer of the second transformer;
obtaining a degree of second correlation of every two characters in the text sample based on the self-attention sub-layer of the target transformer; and
obtaining the first output difference based on a difference between the degree of first correlation and the degree of second correlation of every two characters.
